(19) United States
(12) Patent Application Publication
(10) Pub. No.: US 2026/0307038 A1
(43) Pub. Date: Oct. 8, 2026

(54) MICRO-SCALE CHEMICAL NETWORK SYSTEM AND METHOD FOR REAL-TIME SENSING AND MANIPULATING INTERMEDIATE COMPOUNDING PROCESS IN DYE CHEMISTRY

(71) Applicant: TONGJI UNIVERSITY, Shanghai (CN)

(72) Inventor: Linhua Jiang, Shanghai (CN)

(73) Assignee: TONGJI UNIVERSITY, Shanghai (CN)

(21) Appl. No.: 19/419,754

(22) Filed: Dec. 15, 2025

Related U.S. Application Data
(63) Continuation of application No. PCT/CN2025/090301, filed on Apr. 22, 2025.

(30) Foreign Application Priority Data
Apr. 7, 2025 (CN) 202510425143.5

(51) Int. Cl. B01J 19/00

(52) U.S. Cl. CPC B01J 19/0033; B01J 2219/00186; B01J 2219/00193; B01J 2219/00243

(57) ABSTRACT

A micro-scale chemical network system and method for real-time sensing and manipulating an intermediate compounding process in dye chemistry include a primary, secondary, and tertiary real-time sensing—chemical decision-making—compounding manipulation modules. A closed-loop control method is employed to carry out two measurements and controls on both intermediate compounded liquid and raw materials in each stage. Micro-scale chemical information and macro-scale physical information of feed liquid and the raw material are acquired by a real-time sensing module, theoretical addition amounts of the raw materials are predicted by a chemical decision-making module optimal control model, and a compounding manipulation module dynamically interlocks inlet valves of raw materials to accurately control addition rates, the chemical decision-making module circularly analyzes and determines a deviation between a real-time sensed value of a target species and a model-predicted value, and performs self-adjustment on the model algorithm to correct the deviation.

### CROSS-REFERENCE TO RELATED APPLICATION

This application is a Continuation Application (CA) of International Patent Application No. PCT/CN2025/090301, filed on Apr. 22, 2025, which claims priority of the Chinese Patent Application No. 202510425143.5, filed on Apr. 7, 2025.

### TECHNICAL FIELD

The present disclosure relates to the technical field of clean production in dye chemistry, and in particular to a micro-scale chemical network system and method for real-time sensing and manipulating an intermediate compounding process in dye chemistry.

### BACKGROUND

In the process industries, the concentration of species or the total amount of a substance is closely related to chemical reaction thermodynamics and kinetics, which directly determines whether a unit reaction can proceed and to what extent. In addition, the deviation of the concentration or the species in a production unit on a theoretical value thereof propagates to downstream units and eventually throughout the entire process, which further causes amplified deviations, resulting in reduced conversion efficiency and the generation of pollutants far exceeding theoretical calculations.

The dye industry in China has developed rapidly, with the output ranked first in the world for more than 10 years. However, the industry has gradually entered a mature stage in recent years, and the industrial development is confronted with problems such as overcapacity and environmental pressures. This has created an urgent need for a transformation towards green and high-quality development, and has entered a phase of structural transformation. Disperse dyes, as the only type of dye capable of dyeing and printing polyester fibers (terylene), have become the largest subdivision with the largest output among all dyes. A production process of Disperse Violet 93:1 in enterprises comprises three systems: the first is an intermediate D slurry system, the second is a diazotization system, and the third is a coupling system. The slurry system and the diazotization system are configured to provide intermediates, while the coupling system is configured to synthesize a product. The intermediate D slurry process is a critical step in the synthesis of Disperse Violet, characterized by its complex intermediate, long reaction process, and a high proportion of compounded liquid.

In the actual production process of enterprises, both Intermediate D and the diazonium salt are synthetically produced, high-concentration organic raw materials characterized by constantly fluctuating solid content and purity. In the continuous production process of enterprises, multi-stage intermediates require to be dynamically compounded. At present, the laboratory only carries out off-line detection and analysis (5-6 times/day, 1-2 hours each time) on the acidity of circulating acidic liquid in the intermediate D slurry system and the purity of the artificially synthesized raw material intermediate D, which lacks the detection and analysis of the micro-scale chemical process of the multi-stage intermediate compounding prior to dual combination, and is even more impossible to intervene in or manipulate micro-scale chemical processes, including intermediate D compounding, auxiliary agent compounding, and diazonium salt compounding. Due to the inability to achieve real-time accurate adjustment of an addition amount of the raw material in a high-concentration intermediate compounding process, it is difficult to maintain the total mass of the intermediate D and the total mass of the diazonium salt at a stable and optimal stoichiometric ratio, resulting in reduced reaction efficiency in the disperse violet coupling process, compromised product quality, and increased generation of by-products.

### SUMMARY

An objective of the present disclosure is to provide a micro-scale chemical network system and method for real-time sensing and manipulating an intermediate compounding process in dye chemistry, thereby solving the problems, such as reduced reaction efficiency, compromised product quality, and increased by-products.

To achieve the objective described above, the present disclosure provides the following technical solutions.

In a first aspect, the present disclosure provides a micro-scale chemical network system for real-time sensing and manipulating an intermediate compounding process in dye chemistry based on a primary intermediate compounding reaction process, a secondary intermediate compounding reaction process, and a tertiary intermediate compounding reaction process, and includes:
a primary module, wherein the primary module comprises a primary real-time sensing module, a primary model of a chemical decision-making module, and a primary compounding manipulation module, the first primary module is configured for the primary intermediate compounding process, the primary real-time sensing module is configured for two measurements for rapidly acquiring micro-scale chemical information (purity and solid content of high-concentration intermediate D) of an artificially prepared raw material 1-1 (N, N-diethyl-3-acetamidoaniline, intermediate D for short) and rapidly acquiring micro-scale chemical information (a content of low-concentration intermediate D and a content of sulfuric acid) and macro-scale physical information (total amount of solution in a tank) in a primary feed liquid; a primary intermediate D and acidic liquid accurate addition optimal control model in the chemical decision-making module is configured to predict a theoretical addition amount of a primary compounded organic alkaline raw material 1-1 (high-concentration and high-purity intermediate D in a molten state) and a theoretical addition amount of acidic liquid raw material 1-2 for maintaining stability of a compounding reaction, namely, feedforward-predicted theoretical addition amounts; the primary compounding manipulation module is configured for dynamically and interlockingly two-controlling electric control valves for the raw material 1-1 and the raw material 1-2 to accurately control addition rates; in the primary intermediate compounding reaction process, the primary model of the chemical decision-making module is configured to circularly analyze and determine a deviation between a real-time sensed actual value of an intermediate and a model-predicted theoretical value, and to perform self-adjustment on a model algorithm to correct the deviation, namely, feedback-corrected theoretical addition amounts, until a primary intermediate compounded liquid reaches a theoretical limit prior to outflow;
a secondary module, wherein the secondary module comprises a secondary real-time sensing module, a secondary model of the chemical decision-making module, and a secondary compounding manipulation module; the secondary module is configured for the secondary intermediate compounding process, the secondary real-time sensing module is configured for two measurements for rapidly acquiring micro-scale chemical information (purity and solid content of an auxiliary agent) of an artificially prepared raw material 2-1 (Peregal, urea, auxiliary agent for short) and rapidly acquiring micro-scale chemical information (a content of intermediate D and a content of sulfuric acid) and macro-scale physical information (a total amount of solution in a tank) in a secondary feed liquid; a secondary auxiliary agent and acidic liquid accurate addition optimal control model in the chemical decision-making module is configured to predict a theoretical addition amount of a secondary compounded organic alkaline raw material 2-1 (high-concentration composite auxiliary agent), and a theoretical addition amount of acidic liquid raw material 2-2 for maintaining stability of a compounding reaction, namely, feedforward-predicted theoretical addition amounts; the secondary compounding manipulation module is configured for dynamically and interlockingly two-controlling electric control valves for the raw material 2-1 and the raw material 2-2 to accurately control addition rates; in the secondary intermediate compounding reaction process, the secondary model of the chemical decision-making module is configured to circularly analyze and determine a deviation between a real-time sensed actual value of an intermediate and a model-predicted theoretical value, and to perform self-adjustment on a model algorithm to correct the deviation, namely, feedback-corrected theoretical addition amounts, until a secondary intermediate compounded liquid reaches a theoretical limit prior to outflow; and
a tertiary module, wherein the tertiary module comprises a tertiary real-time sensing module, a tertiary model of the chemical decision-making module, and a tertiary compounding manipulation module; the tertiary real-time sensing module is configured for two measurements for rapidly acquiring micro-scale chemical information (purity and solid content of diazonium salt) of an artificially synthesized raw material 3-1 (6-chloro-2,4-dinitrodiazonium benzene sulfate, diazonium salt for short) and rapidly acquiring micro-scale chemical information (a content of intermediate D and a content of sulfuric acid) and macro-scale physical information (a total amount of solution in tank) in a tertiary feed liquid; a tertiary diazonium salt and acidic liquid accurate addition optimal control model in the chemical decision-making module is configured to predict a theoretical addition amount of a tertiary compounded organic alkaline raw material 3-1 (high-concentration diazonium salt), and a theoretical addition amount of acidic liquid raw material 3-2 for maintaining stability of a compounding reaction, namely, feedforward-predicted theoretical addition amounts; the tertiary compounding manipulation module is configured for dynamically and interlockingly two-controlling electric control valves for the raw material 3-1 and the raw material 3-2 to accurately control addition rates; in the tertiary intermediate compounding reaction process, the tertiary model of the chemical decision-making module is configured to circularly analyze and determine a deviation between a real-time sensed actual value of an intermediate and a model-predicted theoretical value, and to perform self-adjustment on a model algorithm to correct the deviation, namely, feedback-corrected theoretical addition amounts, until a tertiary intermediate compounded effluent reaches a theoretical limit.

As a further solution of the present disclosure, in the primary intermediate compounding reaction process, prior to the reaction, the primary real-time sensing module is configured to sense the micro-scale chemical information (purity and solid content) of the artificially prepared raw material 1-1 (intermediate D) in a raw material tank in real time, and the micro-scale chemical information (the content of intermediate D and the content of sulfuric acid) and the macro-scale physical information (the total amount of solution) of the liquid in the tank prior to the reaction, and to upload data to the primary model of the chemical decision-making module; the primary intermediate D and acidic liquid accurate addition optimal control model is configured to predict the theoretical addition amounts of the raw material 1-1 and the raw material 1-2 and accurately control the addition rates by dynamically interlocking the electric control valves corresponding to the raw material 1-1 and the raw material 1-2 by the primary compounding manipulation module; during reaction, the primary real-time sensing module is configured to sense a change rate of the content of intermediate D with time and stability of acidity in the primary compounding reaction vessel in real time, during which the primary model of the chemical decision-making module is configured to circularly analyze and determine the deviation between the real-time sensed actual value of the intermediate and the model-predicted theoretical value and to perform self-adjustment on the model algorithm to correct the deviation until the primary intermediate compounded liquid reaches the theoretical limit, the primary compounding manipulation module is configured to interlockingly control the electric control valves corresponding to the raw material 1-1 and the raw material 1-2 to be closed; when the reaction stops, the primary compounding manipulation module opens a drain valve of the primary compounding reaction vessel to ensure that the content of intermediate D and the acidity in a primary compounded effluent reach the theoretical limit.

As a further solution of the present disclosure, in the secondary intermediate compounding reaction process, prior to the reaction, the secondary real-time sensing module is configured to sense the micro-scale chemical information (purity and solid content) of the artificially prepared raw material 2-1 (auxiliary agent) in a raw material tank in real time, and the micro-scale chemical information (the content of intermediate D and the content of sulfuric acid) and the macro-scale physical information (the total amount of solution) of the liquid in the tank prior to the reaction, and to upload data to the secondary model of the chemical decision-making module; the secondary auxiliary agent and acidic liquid accurate addition optimal control model is configured to predict the theoretical addition amounts of the raw material 2-1 and the raw material 2-2 and accurately control the addition rates by dynamically interlocking the electric control valves corresponding to the raw material 2-1 and the raw material 2-2 by the compounding manipulation module; during reaction, the secondary real-time sensing module is configured to sense a change rate of the content of intermediate D and the content of auxiliary agent with time and stability of acidity in the secondary compounding reaction vessel in real time, during which the secondary model of the chemical decision-making module is configured to circularly analyze and determine the deviation between the real-time sensed actual value of the intermediate and the model-predicted theoretical value, and to perform self-adjustment on the model algorithm to correct the deviation until the secondary intermediate compounded liquid reaches the theoretical limit, the secondary compounding manipulation module is configured to interlockingly control the electric control valves corresponding to the raw material 2-1 and dilute acid to be closed; when the reaction stops, the secondary compounding manipulation module opens a drain valve of the secondary compounding reaction vessel to ensure that the content of intermediate D, the content of auxiliary agent and the acidity in a secondary compounded effluent reach the theoretical limit.

As a further solution of the present disclosure, in the tertiary intermediate compounding reaction process, prior to the reaction, the tertiary real-time sensing module is configured to sense the micro-scale chemical information (purity and solid content) of the artificially synthesized raw material 3-1 (diazonium salt) in a raw material tank in real time, and the micro-scale chemical information (the content of intermediate D and the content of sulfuric acid) and the macro-scale physical information (the total amount of solution) of the liquid in the tank prior to the reaction, and to upload data to the tertiary model of the chemical decision-making module; the tertiary diazonium salt and acidic liquid accurate addition optimal control model is configured to predict the theoretical addition amounts of the raw material 3-1 and the raw material 3-2 and accurately control the addition rates by dynamically interlocking the electric control valves corresponding to the raw material 3-1 and the raw material 3-2 by the tertiary compounding manipulation module; during reaction, the tertiary real-time sensing module is configured to sense a change rate of the content of intermediate D and the content of diazonium salt with time and stability of acidity in the tertiary compounding reaction vessel in real time, during which the chemical decision-making module is configured to circularly analyze and determine the deviation between the real-time sensed actual value of the intermediate and the model-predicted theoretical value and to perform self-adjustment on the model algorithm to correct the deviation until the tertiary intermediate compounded liquid reaches the theoretical limit, the tertiary compounding manipulation module is configured to interlockingly control the electric control valves corresponding to the raw material 3-1 and the raw material 3-2 to be closed; when the reaction stops, the tertiary compounding manipulation module opens a drain valve of the tertiary compounding reaction vessel to ensure that a total amount of the intermediate D, a total amount of the diazonium salt and the acidity in the tertiary compounded effluent reach the theoretical limit.

As a further solution of the present disclosure, optimal theoretical limits at an end point of the primary intermediate compounding reaction process are as follows: a range of the content of intermediate D is 8.2±0.2%, and the content of sulfuric acid is 3.0±0.2%.

As a further solution of the present disclosure, optimal theoretical limits at an end point of the secondary intermediate compounding reaction process are as follows: a range of the content of intermediate D is 2.8±0.2%, the content of auxiliary agent is 0.35% (0.2% of Peregal and 0.15% of urea), and the content of sulfuric acid is 4.0±0.2%.

As a further solution of the present disclosure, optimal theoretical limits at an end point of the tertiary intermediate compounding reaction process are as follows: the total amount of intermediate D:diazonium salt=1:1 (molar ratio)=206.14:325.94 (mass ratio)=0.33 t/h:0.52 t/h (flow ratio), and the content of sulfuric acid is 2.5±0.2%.

In a second aspect, the present disclosure provides a micro-scale chemical network method for real-time sensing and manipulating an intermediate compounding process, where the method is applied to the system according to any one of claims 1 to 7, and includes the following steps:
S1: introducing circulating acidic liquid containing residual amounts of intermediate D and other species into an intermediate compounding reaction system, and enabling the circulating acidic liquid to flow sequentially in respective reaction tanks in the primary compounding process, the secondary compounding process, and the tertiary compounding process;
S2: enabling the circulating acidic liquid to enter the primary intermediate compounding reaction process, acquiring the micro-scale chemical information and the macro-scale physical information of liquid in the primary compounding process by the primary real-time sensing module, and determining an addition amount of a raw material through feedforward prediction and feedback correction of the primary intermediate D and acidic liquid accurate addition optimal model in the chemical decision-making module, achieving accurate addition through dynamical interlocking by the primary compounding manipulation module, and ending the reaction when a theoretical limit is reached;
S3: enabling a primary effluent to enter the secondary intermediate compounding reaction process, acquiring the micro-scale chemical information and the macro-scale physical information of liquid in the secondary compounding process by the secondary real-time sensing module, and determining an addition amount of a raw material through feedforward prediction and feedback correction of the secondary auxiliary agent and acidic liquid accurate addition optimal model in the chemical decision-making module, achieving accurate addition through dynamical interlocking by the secondary compounding manipulation module, and ending the reaction when a theoretical limit is reached; and
S4: enabling a secondary effluent to enter the tertiary intermediate compounding reaction process, acquiring the micro-scale chemical information and the macro-scale physical information of liquid in the tertiary compounding process by the tertiary real-time sensing module, and determining an addition amount of a raw material by feedforward prediction and feedback correction of the tertiary diazonium salt and acidic liquid accurate addition optimal model in the chemical decision-making module, achieving accurate addition through dynamical interlocking by the tertiary compounding manipulation module, and ending the reaction when a theoretical limit is reached; and enabling a tertiary effluent to enter a next reaction unit coupling system.

Compared with the prior art, the present disclosure has beneficial effects as follows.

In the present disclosure, the micro-scale chemical and macro-scale physical information of feed liquid and raw material are acquired through the real-time sensing module. The theoretical addition amounts of the raw material are predicted by the optimal control model of the chemical decision-making module, and the addition rates are accurately controlled by dynamically interlocking the inlet valves of raw materials through a compounding manipulation module. During the reaction, the chemical decision-making module is configured to circularly analyze and determine the deviation between a real-time sensed value of a target species in the compounded liquid and a model-predicted value and to perform self-adjustment on the model algorithm to correct the deviation, so that the effluent after multi-stage treatment can reach a corresponding theoretical limit. The intermediate quality in the compounding process is effectively improved to provide technical support for scientifically controlling a ratio of the intermediate D to the diazonium salt, effectively increasing the conversion efficiency in the coupling process, greatly improving the product quality of disperse violet, and reducing the generation of pollutant Chemical Oxygen Demand (COD) at the source. This satisfies urgent production needs of enterprises to reduce pollution, reduce carbon, improve quality and increase efficiency.

### BRIEF DESCRIPTION OF THE DRAWINGS

FIG. 1 is a connection diagram of a real-time sensing-chemical decision making-compounding manipulation module according to the present disclosure;

FIG. 2 is a curve graph showing a variation of the purity of an intermediate D according to Embodiment 1 of the present disclosure;

FIG. 3 is a curve graph showing a variation of a solid content of an intermediate D according to Embodiment 1 of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

### Implementation I

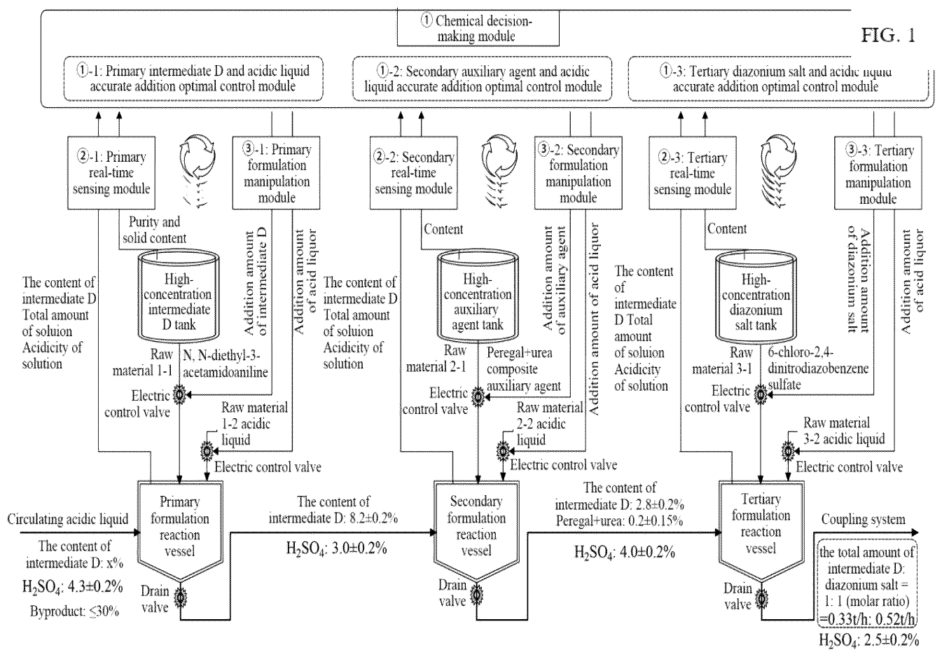

With reference to FIG. 1, in an embodiment of the present disclosure, a micro-scale chemical network system for real-time sensing and manipulating an intermediate compounding process in dye chemistry is provided, where the system is based on a primary intermediate compounding reaction process, a secondary intermediate compounding reaction process, and a tertiary intermediate compounding reaction process, and includes a primary module, a secondary module, and a tertiary module.

The primary module includes a primary real-time sensing module, a primary model of a chemical decision-making module, and a primary compounding manipulation module. The primary module is configured for the primary intermediate compounding reaction process, the primary real-time sensing module is configured for two measurements for rapidly acquiring micro-scale chemical information (purity and solid content) of an artificially prepared raw material 1-1 (intermediate D with high-concentration) and rapidly acquiring micro-scale chemical information (a content of low-concentration intermediate D and a content of sulfuric acid) and macro-scale physical information (total amount of solution in a tank) in a primary feed liquid. A primary optimal control model in the chemical decision-making module is configured to predict a theoretical addition amount of a primary compounded organic alkaline raw material 1-1 (high-concentration and high-purity intermediate D in a molten state), and a theoretical addition amount of acidic liquid 1-2 for maintaining the stability of a compounding reaction, so as to obtain feedforward-predicted theoretical addition amounts. The primary compounding manipulation module is configured for dynamically and interlockingly two-controlling electric control valves for the raw material 1-1 and the raw material 1-2 to accurately control addition rates. In the primary intermediate compounding reaction process, the primary model of the chemical decision-making module is configured to circularly analyze and determine a deviation between a real-time sensed actual value of an intermediate and a model-predicted theoretical value, and to perform self-adjustment on a model algorithm to correct the deviation, so as to obtain a feedback-corrected theoretical addition amount, until a primary intermediate compounded liquid reaches a theoretical limit prior to outflow.

The secondary module includes a secondary real-time sensing module, a secondary model of the chemical decision-making module, and a secondary compounding manipulation module. The secondary module is configured for the secondary intermediate compounding reaction process, the secondary real-time sensing module is configured for two measurements for rapidly acquiring micro-scale chemical information (purity and solid content) of an artificially prepared raw material 2-1 (auxiliary agent) and rapidly acquiring micro-scale chemical information (a content of intermediate D and a content of sulfuric acid) and macro-scale physical information (a total amount of solution in a tank) in a secondary feed liquid. A secondary optimal control model in the chemical decision-making module is configured to predict a theoretical addition amount of a secondary compounded organic alkaline raw material 2-1 (high-concentration composite auxiliary agent), and a theoretical addition amount of acidic liquid 2-2 for maintaining the stability of a compounding reaction, so as to obtain feedforward-predicted theoretical addition amounts. The secondary compounding manipulation module is configured for dynamically and interlockingly two-controlling electric control valves for the raw material 2-1 and the raw material 2-2 to accurately control addition rates. In the secondary intermediate compounding reaction process, the secondary model of the chemical decision-making module is configured to circularly analyze and determine deviations between a real-time sensed actual value of an intermediate and a model-predicted theoretical value, and to perform self-adjustment on the model algorithm to correct the deviation, so as to obtain feedback-corrected theoretical addition amount values, until a secondary intermediate compounded liquid reaches a theoretical limit prior to outflow.

The tertiary module includes a tertiary real-time sensing module, a tertiary model of the chemical decision-making module, and a tertiary compounding manipulation module. The tertiary real-time sensing module is configured for two measurements for rapidly acquiring micro-scale chemical information (purity and solid content) of an artificially synthesized raw material 3-1 (diazonium salt) and rapidly acquiring micro-scale chemical information (a content of intermediate D and a content of sulfuric acid) and macro-scale physical information (a total amount of solution in a tank) in a tertiary feed liquid. A tertiary optimal control model in the chemical decision-making module is configured to predict a theoretical addition amount of a tertiary compounded organic alkaline raw material 3-1 (high-concentration diazonium salt), and a theoretical addition amount of acidic liquid 3-2 for maintaining the stability of a compounding reaction, so as to obtain feedforward-predicted theoretical addition amounts. The tertiary compounding manipulation module is configured for dynamically and interlockingly two-controlling electric control valves for the raw material 3-1 and the raw material 3-2 to accurately control addition rates. In the tertiary intermediate compounding reaction process, the tertiary model of the chemical decision-making module is configured to circularly analyze and determine a deviation between a real-time sensed actual value of an intermediate and a model-predicted theoretical value, and to perform self-adjustment on the model algorithm to correct the deviation, so as to obtain a feedback-corrected theoretical addition amount, until a tertiary intermediate compounded effluent reaches a theoretical limit.

Specifically, in the present disclosure, the micro-scale chemical and macro-scale physical information of feed liquid and raw material are acquired through the real-time sensing module. The theoretical addition amounts of the raw material are predicted by the optimal control model of the chemical decision-making module, and the addition rates are accurately controlled by dynamically interlocking the inlet valves of raw materials through a compounding manipulation module. During the reaction, the chemical decision-making module is configured to circularly analyze and determine the deviation between a real-time sensed value of a target species in the compounded liquid and a model-predicted value and to perform self-adjustment on the model algorithm to correct the deviation, so that the effluent after multi-stage treatment can reach a corresponding theoretical limit. The intermediate quality in the compounding process is effectively improved to provide technical support for scientifically controlling a ratio of the intermediate D to the diazonium salt, effectively increasing the conversion efficiency in the coupling process, greatly improving the product quality of disperse violet, and reducing the generation of pollutant Chemical Oxygen Demand (COD) at the source. This satisfies urgent production needs of enterprises to reduce pollution, reduce carbon, improve quality and increase efficiency.

Preferably, in the primary intermediate compounding reaction process, prior to the reaction, the primary real-time sensing module is configured to sense the micro-scale chemical information (purity and solid content) of the artificially prepared raw material 1-1 (intermediate D) in a raw material tank in real time, and the micro-scale chemical information (the content of intermediate D and the content of sulfuric acid) and the macro-scale physical information (the total amount of solution) of the liquid in a tank prior to the reaction, and to upload data to the chemical decision-making module; the primary optimal control model is configured to predict the theoretical addition amounts of the raw material 1-1 and the acidic liquid 1-2 and accurately control the addition rates by dynamically interlocking the electric control valves corresponding to the raw materials 1-1 and 1-2 by the primary compounding manipulation module; during reaction, the primary real-time sensing module is configured to sense a change rate of the content of intermediate D with time and the stability of acidity in the primary compounding reaction vessel in real time, during which the chemical decision-making module is configured to circularly analyze and determine the deviation between the real-time sensed actual value of the intermediate and the model-predicted theoretical value and to perform self-adjustment on the model algorithm to correct the deviation until the primary intermediate compounded liquid reaches the theoretical limit, the primary compounding manipulation module is configured to interlockingly control the electric control valves corresponding to the raw materials 1-1 and 1-2 to be closed; when the reaction stops, the primary compounding manipulation module opens a drain valve of the primary compounding reaction vessel to ensure that the content of intermediate D and the acidity in a primary compounded effluent reach the theoretical limit.

Preferably, in the secondary intermediate compounding reaction process, prior to the reaction, the secondary real-time sensing module is configured to sense the micro-scale chemical information (purity and solid content) of the artificially prepared raw material 2-1 (auxiliary agent) in a raw material tank in real time, and the micro-scale chemical information (the content of intermediate D and the content of sulfuric acid) and the macro-scale physical information (the total amount of solution) of the liquid in a tank prior to the reaction, and to upload data to the chemical decision-making module; the secondary auxiliary optimal control model is configured to predict the theoretical addition amounts of the raw material 2-1 and the acidic liquid 2-2 and accurately control the addition rates by dynamically interlocking the electric control valves corresponding to the raw materials 2-1 and 2-2 by the secondary compounding manipulation module; during reaction, the secondary real-time sensing module is configured to sense a change rate of the content of intermediate D and the content of auxiliary agent with time and the stability of acidity in the secondary compounding reaction vessel in real time, during which the chemical decision-making module is configured to circularly analyze and determine the deviation between the real-time sensed actual amount and the model-predicted theoretical addition amount of the intermediate and to perform self-adjustment on the model algorithm to correct the deviation until the secondary intermediate compounded liquid reaches the theoretical limit, the secondary compounding manipulation module is configured to interlockingly control the electric control valves corresponding to the raw material 2-1 and 2-2 to be closed; when the reaction stops, the secondary compounding manipulation module opens a drain valve of the secondary compounding reaction vessel to ensure that the content of intermediate D, the content of auxiliary agent and the acidity in a secondary compounded effluent reach the theoretical limit.

Preferably, in the tertiary intermediate compounding reaction process, prior to the reaction, the tertiary real-time sensing module is configured to sense the micro-scale chemical information (purity and solid content) of the artificially synthesized raw material 3-1 (diazonium salt) in a raw material tank in real time, and the micro-scale chemical information (the content of intermediate D and the content of sulfuric acid) and the macro-scale physical information (the total amount of solution) of the liquid in a tank prior to the reaction, and to upload data to the chemical decision-making module; the tertiary optimal control model is configured to predict the theoretical addition amounts of the raw material 3-1 and the acidic liquid 3-2 and accurately control the addition rates by dynamically interlocking the electric control valves corresponding to the raw materials 3-1 and 3-2 by the tertiary compounding manipulation module; during reaction, the tertiary real-time sensing module is configured to sense a change rate of the content of intermediate D and a content of diazonium salt with time and stability of acidity in the tertiary compounding reaction vessel in real time, during which the chemical decision-making module is configured to circularly analyze and determine the deviation between the real-time sensed actual value of the intermediate and the model-predicted theoretical value and to perform self-adjustment on the model algorithm to correct the deviation until the tertiary intermediate compounded liquid reaches the theoretical limit, the tertiary compounding manipulation module is configured to interlockingly control the electric control valves corresponding to the raw materials 3-1 and 3-2 to be closed; when the reaction stops, the tertiary compounding manipulation module opens a drain valve of the tertiary compounding reaction vessel to ensure that a total amount of the intermediate D, a total amount of the diazonium salt and the acidity in the tertiary compounded effluent reach the theoretical limit.

Preferably, optimal theoretical limits at an end point of the primary intermediate compounding reaction process are as follows: a range of the content of intermediate D is 8.2±0.2%, and the content of sulfuric acid is 3.0±0.2%.

Preferably, optimal theoretical limits at an end point of the secondary intermediate compounding reaction process are as follows: a range of the content of intermediate D is 2.8±0.2%, the content of auxiliary agent is 0.35% (0.2% of Peregal and 0.15% of urea), and the content of sulfuric acid is 4.0±0.2%.

Preferably, optimal theoretical limits at an end point of the tertiary intermediate compounding reaction process are as follows: the total amount of intermediate D:diazonium salt=1:1 (molar ratio)=206.14:325.94 (mass ratio)=0.33 t/h:0.52 t/h (flow ratio), and the content of sulfuric acid is 2.5±0.2%.

A micro-scale chemical network method for real-time sensing and manipulating an intermediate compounding process in dye chemistry includes the following steps S1 to S4.

In step S1, circulating acidic liquid containing residual amounts of intermediate D and other species are introduced into an intermediate compounding reaction system, and the circulating acidic liquid flows sequentially in respective reaction vessels in the primary, secondary, and tertiary intermediate compounding reaction processes.

In step S2, the circulating acidic liquid enters the primary intermediate compounding reaction process, the micro-scale chemical information and the macro-scale physical information of liquid in the primary intermediate compounding reaction process are acquired by the primary real-time sensing module, and the addition amounts of raw materials are determined through feedforward prediction and feedback correction of the primary intermediate D and acidic liquid accurate addition optimal model in the chemical decision-making module, accurate addition is achieved through dynamical interlocking by the primary compounding manipulation module, and the compounding reaction stops when the theoretical limit is reached.

In step S3, a primary effluent enters the secondary intermediate compounding reaction process, the micro-scale chemical information and the macro-scale physical information of liquid in the secondary intermediate compounding reaction process are acquired by the secondary real-time sensing module, and the addition amounts of raw materials are determined through feedforward prediction and feedback correction of the secondary auxiliary agent and acidic liquid accurate addition optimal model in the chemical decision-making module, accurate addition is achieved through dynamical interlocking by the secondary compounding manipulation module, and the compounding reaction stops when a theoretical limit is reached.

In step S4, a secondary effluent enters the tertiary intermediate compounding reaction process, the micro-scale chemical information and the macro-scale physical information of liquid in the tertiary intermediate compounding reaction process are acquired by the tertiary real-time sensing module, and the addition amounts of raw materials are determined through feedforward prediction and feedback correction of the tertiary diazonium salt and acidic liquid accurate addition optimal model in the chemical decision-making module, accurate addition is achieved through dynamical interlocking by a tertiary compounding manipulation module, and the compounding reaction stops when a theoretical limit is reached. A tertiary effluent enters a next reaction unit coupling system.

### Embodiment

As shown in a chemical reaction equation for the coupling synthesis of Disperse Violet 93:1 (see Table 1), in the chemical reaction, a molar ratio of the intermediate D to diazonium salt is 1:1, and a mass ratio is 206.14:325.94. In the actual production process of enterprises, both the intermediate D and the diazonium salt are artificially synthesized high-concentration organic raw materials with constantly fluctuating solid content and purity. In the continuous production process of enterprises, multi-stage intermediates need to be dynamically compounded, which includes accurately adding an intermediate D in a first stage for intermediate compounding, accurately adding an auxiliary agent in a second stage for intermediate compounding, and adding a diazonium salt in a third stage for intermediate compounding, so that the compounded liquid in each phase can reach a predetermined target limit prior to outflow, thereby ensuring that the total mass of the Intermediate D and the total mass of the diazonium salt are kept at a stable and rational ratio at any given moment prior to entering the coupling reaction.

TABLE 1
Basic information of micro-scale chemical reaction
Disperse Violet 93:1 coupling reaction: diazonium salt + intermediate D → Disperse violet
(93:1) + sulfuric acid

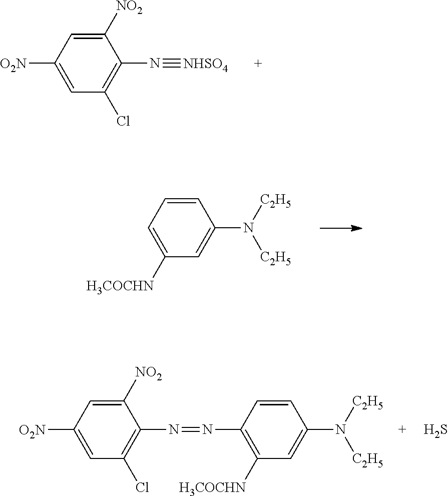

| | | |
|---|---|---|
| Diazonium salt | Intermediate D | Disperse violet 93:1 |
| 6-chloro-2,4-dinitro- | N,N-diethyl-3- | N-(2-((2-chloro-4,6-dinitrophenyl)azo)-5- |
| benzenediazonium | acetamidoaniline | (diethylamino)phenyl)acetamide |
| sulfate | 206.14 g/mol | 434.11 g/mol |
| 325.94 g/mol | | |

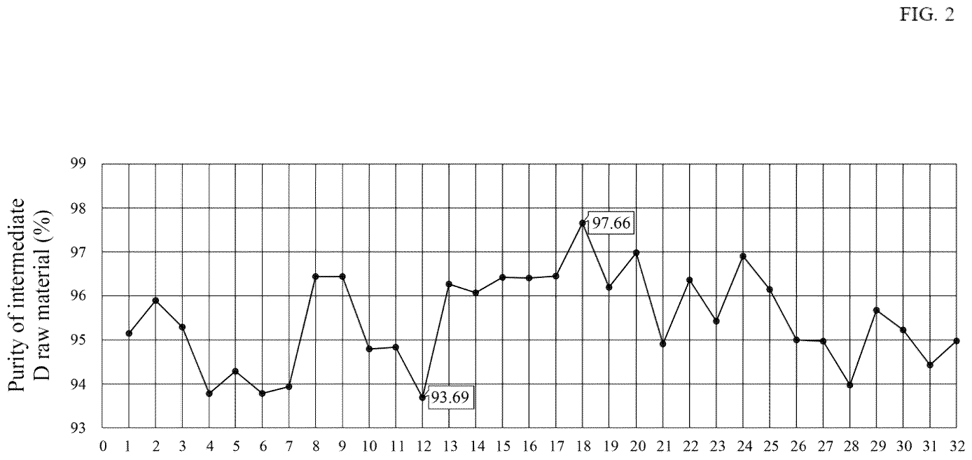

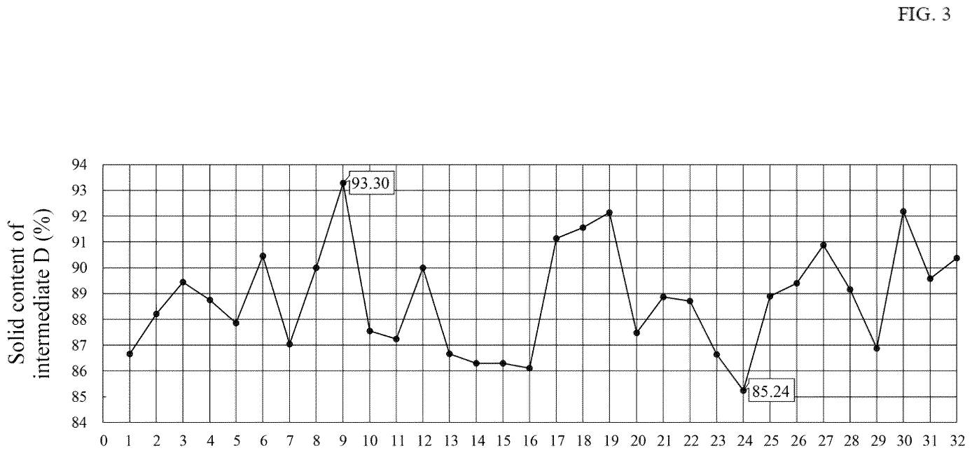

The micro-scale chemical information and macro-scale physical information of circulating acidic liquid, a first raw material, a second raw material, a third raw material and dilute acidic liquid in the primary, secondary and tertiary intermediate compounding reaction processes are shown in Table 2. Change curves of the purity and solid content of the intermediate D in the first raw material are shown in FIG. 2 to FIG. 3.

TABLE 2
Micro-scale chemical information and macro-scale physical information of species

| | | | Second raw | Third raw | |
|---|---|---|---|---|---|
| | | First raw | material- | material- | |
| Species | Circulating | material- | Auxiliary | Diazonium | Dilute acidic |
| information | acidic liquid | Intermediate D | agent | salt | liquid-H₂SO₄ |
| Content of | C1: 0-1 | | | | |
| intermediate D | | | | | |
| (%) | | | | | |
| Purity of | | P1: 93.69- | | | |
| intermediate D | | 97.66 | | | |
| (%) | | | | | |
| Solid content of | | S1: 85.24- | | | |
| intermediate D | | 93.30 | | | |
| (%) | | | | | |
| Content of | | | C2: 98-99 | | |
| auxiliary agent | | | | | |
| (%) | | | | | |
| Content of | | | | C3: 44-48 | |
| diazonium salt | | | | | |
| (%) | | | | | |
| Content of | H1: | | | | H2: 4.5% |
| H₂SO₄ (%) | 4.3 ± 0.2 | | | | |
| Total amount of | M1: 10000- | | | | |
| solution (kg) | 12000 | | | | |

### 1. Prediction on the Addition Amounts of Intermediate D and Dilute Acid by a Primary Intermediate Compounding Model

### 1.1. Data of a Primary Real-Time Sensing Module

The content (C1) of intermediate D, the content (H1) of sulfuric acid, the total amount (M1) of solution in the circulating acidic liquid, and the purity and solid content of the first raw material (intermediate D) are always in dynamic change. It is assumed that real-time sensed values prior to a primary compounding are as follows: the content C1 of intermediate D is 1.0%, the content H1 of sulfuric acid is 4.2%, and the total amount M1 of the solution is 10000 kg; and in the raw material, intermediate D has the purity P1 of 95%, and the solid content S1 of 90%.

### 1.2. Prediction and Correction of a Primary Model of Chemical Decision-Making Module

As optimal theoretical limits at an end point of the primary intermediate compounding reaction process are as follows: a range of the content of intermediate D is 8.2±0.2%, and the content of sulfuric acid is 3.0±0.2%, for the intermediate D, it is only required to solve the addition amount m₁ of the first raw material under the condition that the content of intermediate D at an end point of a primary reaction is 8.0%≤C_{effluent1}≤8.4%, that is,

$$8. \% \leq \frac{C 1 \times M 1 + {m}_{1} \times P 1 \times S 1}{{m}_{1} + M 1} \leq 8.4 \% .$$

A primary intermediate D and acidic liquid accurate addition theoretical optimal control model is

$$\frac{M 1 \times ( 8. \% - C 1 )}{P1 \times S 1 - 8. \%} \leq {m}_{1} \leq \frac{M 1 \times ( 8.4 \% - C 1 )}{P 1 \times S 1 - 8.4 \%} .$$

The following simultaneous system of equations is solved:

$${m}_{1} \geq \frac{M 1 \times ( 8. \% - C 1 )}{P 1 \times S 1 - 8. \%} , \qquad ( 1 )$$

$${m}_{1} \leq \frac{M 1 \times ( 8.4 \% - C 1 )}{P 1 \times S 1 - 8.4 \%} . \qquad ( 2 )$$

The real-time sensed data in “1.1” are substituted into the simultaneous system of equations to obtain:

$${m}_{1} \geq \frac{M 1 \times ( 8. \% - C 1 )}{P 1 \times S 1 - 8. \%} = \frac{10000 \times ( 8. \% - 1 \% )}{95 \% \times 90 \% - 8. \%} = 903.23 kg , \qquad ( 1 )$$

$${m}_{1} \leq \frac{M 1 \times ( 8.4 \% - C 1 )}{P 1 \times S 1 - 8.4 \%} = \frac{10000 \times ( 8.4 \% - 1 \% )}{95 \% \times 90 \% - 8.4 \%} = 954.84 kg . \qquad ( 2 )$$

It can be learned that when the requirements of (1) and (2) are satisfied at the same time, the theoretical addition amount of m₁ is: 903.23 kg≤m₁≤954.84 kg, that is: ΔC_{theory}=(C_{effluent1}−C₁)~m₁

It is assumed that when the theoretical addition amount m₁ of the first raw material is 920 kg, the content of intermediate D at the end point of the primary compounding can be as follows:

### Theoretical

$${C}_{effluent 1 =} \frac{C 1 \times M 1 + {m}_{1} \times P 1 \times S 1}{{m}_{1} + M 1} = \frac{1 \% \times 10000 + 920 \times 95 \% \times 90 \%}{920 + 10000} = 8.12 \%$$

If the real-time sensed intermediate D concentration no longer increases after increasing to 8.10% in the actual reaction process, that is, the actual C_{effluent1}=8.10%, a concentration deviation is ΔC=(theoretical C_{effluent1}−actual C_{effluent1})=8.12%−8.10%=0.02%, and a correction amount of the addition amount of the first raw material can be calculated accordingly as follows:

$$Δ {m}_{1} = \frac{M 1 \times ( 8.12 \% - C 1 )}{P 1 \times S 1 - 8.12 \%} - \frac{M 1 \times ( 8.1 \% - C 1 )}{P 1 \times S 1 - 8.1 \%} = \frac{10000 \times ( 8.12 \% - 1 \% )}{95 \% \times 90 \% - 8.12 \%} - \frac{10000 \times ( 8.1 \% - C 1 )}{95 \% \times 90 \% - 8.1 \%} = 920.13 - 91 \; 7.31 = 2.82$$

It can be learned that the theoretical m₁ is 920 kg, the actual m₁ is 920+2.82=922.82 kg, and a model correction absorption

$${K}_{1} = \frac{92 \; 2.82}{920} = 1. 3 .$$

The chemical decision-making module is configured for circular analysis, determination and self-correction, the primary intermediate D accurate addition optimal control model is as follows:

The model after primary correction: actual m₁=K₁×theoretical m₁,

The model after secondary correction: actual m₁=K₁×theoretical m₁, . . . .

The model after N^{th} correction: actual m₁=K₁×theoretical m₁.

A primary intermediate D accurate addition optimal control model is finally obtained under the condition that the effluent meets limiting requirements:

$$\frac{M 1 \times ( 8. \% - C 1 )}{P 1 \times S 1 - 8. \%} \underline{<} {K}_{N} * {m}_{1} \underline{<} \frac{M 1 \times ( 8.4 \% - C 1 )}{P 1 \times S 1 - 8.4 \%} .$$

Secondly, as the intermediate D is an alkaline organic matter, which is subjected to a neutralization reaction during the addition process, leading to the decrease of acidity of the compounded liquid. To maintain stable operation of the primary intermediate compounding reaction, a supplement amount of the dilute acid is dynamically adjusted to keep the solution at a certain acidity value of 3.0±0.2% according to the change of the acidity of the solution caused by the addition amount of the intermediate D in the compounding process.

### 2. Prediction on the Addition Amounts of Auxiliary Agent and Dilute Acid by a Secondary Intermediate Compounding Model

### 2.1. Data of a Secondary Real-Time Sensing Module

The content (C_{effluent1}) of intermediate D, the content (H_{effluent1}) of sulfuric acid and the total amount (M_{effluent1}) of solution in a primary effluent, and the content (C2) of the second raw material (auxiliary agent) are always in dynamic change. It is assumed that real-time sensed values prior to a secondary compounding are as follows: the content C_{effluent1} of intermediate D is 8.2%, the content H_{effluent1} of sulfuric acid is 3.0%, and the total amount M_{effluent1} of the solution is 4000 kg; and the content C2 of auxiliary agent is 98%.

### 2.2. Prediction and Correction of a Secondary Model of Chemical Decision-Making Module

As optimal theoretical limits at an end point of the secondary intermediate compounding reaction process are as follows: a range of the content of intermediate D is 2.8±0.2%, the content of auxiliary agent is 0.35% (0.2% of Peregal and 0.15% of urea), and the content of sulfuric acid is 4.0±0.2%. For the intermediate D and the auxiliary agent, it is required to solve the following that satisfies conditions at the end point of the secondary reaction: (1) an addition amount m₂₋₁ of the dilute acid under the conditions that the content of intermediate D is 2.6%≤C_{effluent2}≤3.0%, and the content of sulfuric acid is 2.6%≤H_{effluent2}≤3.0%; and (2) an addition amount m₂₋₂ of the second raw material under the condition that the content of auxiliary agent is 0.35%.

The following simultaneous system of equations is solved:

$$2.6 \% \leq \frac{{C}_{effluent 1} \times {M}_{effluent 1}}{{M}_{effluent 1} + {m}_{2 - 1}} \leq 3. \% \qquad ( 1 )$$

$$3.8 \% \leq \frac{{H}_{efflluent 1} \times {M}_{effluent 1} + {m}_{2 - 1} \times H 2}{{M}_{effluent 1} + {m}_{2 - 1}} \leq 4.2 \% \qquad ( 2 )$$

When the content of intermediate D (2.8±0.2%) in the secondary compounded effluent is satisfied, a secondary auxiliary agent and dilute acid accurate addition theoretical optimal control model is as follows:

$$\frac{{M}_{effluent 1} \times ( {C}_{effluent 1} - 3. \% )}{3. \%} \leq {m}_{2 - 1} \leq \frac{{M}_{effluent 1} \times ( {C}_{effluent 1} - 2.6 \% )}{2.6 \%}$$

The simultaneous system of equations (1) is solved:

$${m}_{2 - 1} \geq \frac{{M}_{effluent 1} \times ( {C}_{effluent 1} - 3. \% )}{3. \%} \qquad ( 1 ‐ 1 )$$

$${m}_{2 - 1} \leq \frac{{M}_{effluent 1} \times ( {C}_{effluent 1} - 2.6 \% )}{2.6 \%} \qquad ( 1 ‐ 2 )$$

The real-time sensed data in “2.1” are substituted into the simultaneous system of equations, so that:

$${m}_{2 - 1} \geq \frac{{M}_{effluent 1} \times ( {C}_{effluent 1} - 3. \% )}{3. \%} = \frac{4000 \times ( 8.2 \% - 3. \% )}{3. \%} = 6933.33 kg \qquad ( 1 ‐ 1 )$$

$${m}_{2 - 1} \leq \frac{{M}_{effluent 1} \times ( {C}_{effluent 1} - 2.6 \% )}{3. \%} = \frac{4000 \times ( 8.2 \% - 2.6 \% )}{2.6 \%} = 8615.38 kg \qquad ( 1 ‐ 2 )$$

It can be learned that when the requirements of (1) are satisfied, the theoretical addition amount of m₂₋₁ is: 6933.33 kg≤m₂₋₁≤8615.38 kg.

When the content of sulfuric acid D (4.0±0.2%) in the secondary compounded effluent is satisfied, the secondary auxiliary agent and dilute acid accurate addition theoretical optimal control model is as follows:

$$\frac{{M}_{effluent 1} \times ( 3.8 \% - {H}_{effluent 1} )}{H 2 - 3.8 \%} \leq {m}_{2 - 1} \leq \frac{{M}_{effluent 1} \times ( 4.2 \% - {H}_{effluent 1} )}{H 2 - 4.2 \%}$$

The simultaneous system of equations (2) is solved:

$${m}_{2 - 1} \geq \frac{{M}_{effluent 1} \times ( 3.8 \% - {H}_{effluent 1} )}{H2 - 3.8 \%} \qquad ( 2 ‐ 1 )$$

$${m}_{2 - 1} \leq \frac{{M}_{effluent 1} \times ( 4.2 \% - {H}_{effluent 1} )}{H 2 - 4.2 \%} \qquad ( 2 ‐ 2 )$$

The real-time sensed data in “2.1” are substituted into the simultaneous system of equations, so that:

$${m}_{2 - 1} \geq \frac{{M}_{effluent 1} \times ( 3.8 \% - {H}_{effluent 1} )}{H 2 - 3.8 \%} = \frac{4000 \times ( 3.8 \% - 3. \% )}{4.5 - 3.8 \%} = 4571.43 kg \qquad ( 2 ‐ 1 )$$

$${m}_{2 - 1} \leq \frac{{M}_{effluent1} \times ( 4.2 \% - {H}_{effluent 1} )}{H 2 - 4.2 \%} = \frac{4000 \times ( 4.2 \% - 3. \% )}{4.5 - 4.2 \%} = 16000. kg \qquad ( 2 ‐ 2 )$$

It can be learned that when the requirements of (1) and (2) are satisfied, the theoretical addition amount of m₂₋₁ is: 6933.33 kg≤m₂₋₁≤8615.38 kg.

Assuming that the addition amount m₂₋₁ of the dilute acid is 8000 kg, the addition amount m₂₋₂ of the second raw material is calculated on a condition that an auxiliary content at the end point of the secondary reaction is 0.35%.

A secondary compounding auxiliary agent accurate addition theoretical optimal control model is as follows:

$$\frac{{m}_{2 - 2} \times 98 \%}{{M}_{effluent 1} + {m}_{2 - 1} + {m}_{2 - 2}} = 3.5 \%$$

The equation (3) is solved:

$${m}_{2 - 2} = \frac{( {M}_{effluent 1} + {m}_{2 - 1} ) \times 3.5 \%}{98 \% - 3.5 \%}$$

The real-time sensed data in “2.1” and (1) are substituted into the simultaneous system of equations, so that:

$${m}_{2 - 2} = \frac{( {M}_{effluent 1} + {m}_{2 - 1} ) \times 3.5 \%}{9.8 \% - 3.5 \%} = \frac{( 4000 + 8000 ) \times 3.5 \%}{98 \% - 3.5 \%} = 444.44 kg \qquad ( 3 )$$

It can be learned that when the requirements of (3) are satisfied, the theoretical addition amount of m₂₋₂ is: m₂₋₂=444.44 kg.

Through the chemical decision-making module which makes circular analysis and determination for self-correction in “2.1”, the following conditions which meet the limiting conditions of the secondary compounding are finally obtained: (1) the addition amount m₂₋₁ of the dilute acid under the conditions that the content of intermediate D is 2.6%≤C_{effluent2}≤3.0%, and the content of sulfuric acid is 2.6%≤H_{effluent2}≤3.0%; and (2) an addition amount m₂₋₂ of the second raw material under the condition that the content of auxiliary agent is 0.35%.

The dilute acid addition optimal control model is as follow:

$$\frac{{M}_{effluent 1} \times ( {c}_{effluentt 1} - 3. \% )}{3. \%} \leq {K}_{N} * {m}_{2 - 1} \leq \frac{{M}_{effluent 1} \times ( {C}_{effluent 1} - 2.6 \% )}{2.6 \%} \qquad ( 1 )$$

$$\frac{{M}_{effluent 1} \times ( 3.8 \% - {H}_{effluent 1} )}{H 2 - 3.8 \%} \leq {K}_{N} * {m}_{2 - 1} \leq \frac{{M}_{effluent 1} \times ( 4.2 \% - {H}_{effluent 1} )}{H 2 - 4.2 \%} \qquad ( 2 )$$

The auxiliary agent addition optimal control model:

$${K}_{N} * {m}_{2 - 2} = \frac{( {M}_{effluent 1} + {m}_{2 - 1} ) \times 3.5 \%}{98 \% - 3.5 \%} \qquad ( 3 )$$

### 3. Prediction on the Addition Amounts of Diazonium Salt and Dilute Acid by a Tertiary Intermediate Compounding Model

### 3.1. Data of a Tertiary Real-Time Sensing Module

The content (C_{effluent2}) of intermediate D, the content (H_{effluent2}) of sulfuric acid and the total amount (M_{effluent2}) of solution in a secondary effluent, and the content (C3) of third raw material (diazonium salt) are always in dynamic change. It is assumed that real-time sensed values prior to a tertiary compounding are as follows: the content C_{effluent2} of intermediate D is 2.8%, the content H_{effluent2} of sulfuric acid is 4.0%, and the total amount M_{effluent2} of the solution is 12000 kg; and the content C3 of diazonium salt is 46%.

### 3.2. Prediction and Correction of a Tertiary Model of Chemical Decision-Making Module

As optimal theoretical limits at an end point of the primary intermediate compounding reaction process and optimal theoretical limits at an end point of the tertiary intermediate compounding reaction process are as follows: the total amount of intermediate D: the amount of diazonium salt=1:1 (molar ratio)=206.14:325.94 (mass ratio)=0.33 t/h:0.52 t/h (flow ratio). For the diazonium salt, it is required to solve for an addition amount m₃ of the third raw material under the condition that a ratio of the total amount of intermediate D to the total amount of diazonium salt at the end point of the primary reaction per hour is 0.33 t:0.52 t.

The tertiary compounded diazonium salt accurate addition theoretical optimal control model is as follows:

$$\frac{{C}_{effluent 2} \times {M}_{effluent 2}}{C 3 \times {m}_{3}} = \frac{0.33}{0.52}$$

The equation is solved:

$${m}_{3} = \frac{0.52 \times {C}_{effluent 2} \times {M}_{effluent 2}}{0.33 \times C 3} .$$

The real-time sensed data in “3.1” are substituted into the equation:

$${m}_{3} = \frac{0.52 \times {C}_{effluent 2} \times {M}_{effluent 2}}{0.33 \times C 3} = \frac{0.52 \times 2.8 \% \times 12000}{0.33 \times 46 \%} = 1150.99 kg$$

It can be learned that when the requirements of the tertiary compounding are satisfied, the theoretical addition amount m₃ of diazonium salt is 1150.99 kg.

Through the chemical decision-making module which makes continuous analysis and determination for self-correction in “3.1”, a tertiary diazonium salt accurate addition optimal control model is finally obtained under the condition that the effluent meets limiting requirement:

$${K}_{N} * {m}_{3} = \frac{0.52 \times {C}_{effluent 2} \times {M}_{effluent 2}}{0.33 \times C 3} .$$

Secondly, as the diazonium salt is an alkaline organic substance, which is subjected to a neutralization reaction during the addition process, leading to the decrease of acidity of the compounded liquid. To maintain stable operation of the tertiary intermediate compounding reaction, a supplement amount of the dilute acid is dynamically adjusted to keep the solution at a certain acidity value of 2.5±0.2% according to the change of the acidity of the solution caused by the addition amount of the diazonium salt in the compounding process.

The foregoing is only a preferred specific implementation of the present disclosure, but the scope of protection of the present disclosure is not limited thereto. Equivalent replacements or modifications made by any person skilled in the art within the technical scope disclosed in the present disclosure based on the technical solutions and inventive concepts of the present disclosure shall be encompassed within the scope of protection of the present disclosure.

What is claimed is:

1. A micro-scale chemical network system for real-time sensing and manipulating an intermediate compounding process in dye chemistry, based on a primary intermediate compounding reaction process, a secondary intermediate compounding reaction process, and a tertiary intermediate compounding reaction process, comprising:
a primary module, wherein the primary module comprises a primary real-time sensing module, a primary model of a chemical decision-making module, and a primary compounding manipulation module, the first primary module is configured for the primary intermediate compounding process, the primary real-time sensing module is configured for two measurements for rapidly acquiring micro-scale chemical information of an artificially prepared raw material 1-1 and rapidly acquiring micro-scale chemical information and macro-scale physical information in a primary feed liquid, wherein the micro-scale chemical information of the artificially prepared raw material 1-1 comprise purity and solid content of intermediate D in the artificially prepared raw material 1-1, the micro-scale chemical information of the primary feed liquid comprise a content of intermediate D and a content of sulfuric acid in the primary feed liquid, and the macro-scale physical information of the primary feed liquid comprise total amount of solution in a tank of the primary feed liquid; the primary model of the chemical decision-making module is configured to predict a theoretical addition amount of a primary compounded organic alkaline raw material 1-1 and a theoretical addition amount of acidic liquid raw material 1-2 for maintaining stability of a compounding reaction, namely, feedforward-predicted theoretical addition amounts; the primary compounding manipulation module is configured for dynamically and interlockingly two-controlling electric control valves for the raw material 1-1 and the raw material 1-2 to accurately control addition rates; in the primary intermediate compounding reaction process, the primary model of the chemical decision-making module is configured to circularly analyze and determine a deviation between a real-time sensed actual value of an intermediate and a model-predicted theoretical value, and to perform self-adjustment on a model algorithm to correct the deviation, namely, feedback-corrected theoretical addition amounts, until a primary intermediate compounded liquid reaches a theoretical limit prior to outflow;
a secondary module, wherein the secondary module comprises a secondary real-time sensing module, a secondary model of the chemical decision-making module, and a secondary compounding manipulation module; the secondary module is configured for the secondary intermediate compounding process, the secondary real-time sensing module is configured for two measurements for rapidly acquiring micro-scale chemical information of an artificially prepared raw material 2-1 and rapidly acquiring micro-scale chemical information and macro-scale physical information in a secondary feed liquid, wherein the micro-scale chemical information of the artificially prepared raw material 2-1 comprise purity and solid content of auxiliary agent in the artificially prepared raw material 2-1, the micro-scale chemical information of the secondary feed liquid comprise a content of intermediate D and a content of sulfuric acid in the secondary feed liquid, and the macro-scale physical information of the secondary feed liquid comprise total amount of solution in a tank of the secondary feed liquid; the secondary model of the chemical decision-making module is configured to predict a theoretical addition amount of a secondary compounded organic alkaline raw material 2-1, and a theoretical addition amount of acidic liquid raw material 2-2 for maintaining stability of a compounding reaction, namely, feedforward-predicted theoretical addition amounts; the secondary compounding manipulation module is configured for dynamically and interlockingly two-controlling electric control valves for the raw material 2-1 and the raw material 2-2 to accurately control addition rates; in the secondary intermediate compounding reaction process, the secondary model of the chemical decision-making module is configured to circularly analyze and determine a deviation between a real-time sensed actual value of an intermediate and a model-predicted theoretical value, and to perform self-adjustment on a model algorithm to correct the deviation, namely, feedback-corrected theoretical addition amounts, until a secondary intermediate compounded liquid reaches a theoretical limit prior to outflow; and
a tertiary module, wherein the tertiary module comprises a tertiary real-time sensing module, a tertiary model of the chemical decision-making module, and a tertiary compounding manipulation module; the tertiary real-time sensing module is configured for two measurements for rapidly acquiring micro-scale chemical information of an artificially synthesized raw material 3-1 and rapidly acquiring micro-scale chemical information and macro-scale physical information in a tertiary feed liquid, wherein the micro-scale chemical information of the artificially prepared raw material 3-1 comprise purity and solid content of diazonium salt in the artificially prepared raw material 3-1, the micro-scale chemical information of the tertiary feed liquid comprise a content of intermediate D and a content of sulfuric acid in the tertiary feed liquid, and the macro-scale physical information of the tertiary feed liquid comprise total amount of solution in a tank of the tertiary feed liquid; the tertiary model of the chemical decision-making module is configured to predict a theoretical addition amount of a tertiary compounded organic alkaline raw material 3-1, and a theoretical addition amount of acidic liquid raw material 3-2 for maintaining stability of a compounding reaction, namely, feedforward-predicted theoretical addition amounts; the tertiary compounding manipulation module is configured for dynamically and interlockingly two-controlling electric control valves for the raw material 3-1 and the raw material 3-2 to accurately control addition rates; in the tertiary intermediate compounding reaction process, the tertiary model of the chemical decision-making module is configured to circularly analyze and determine a deviation between a real-time sensed actual value of an intermediate and a model-predicted theoretical value, and to perform self-adjustment on a model algorithm to correct the deviation, namely, feedback-corrected theoretical addition amounts, until a tertiary intermediate compounded effluent reaches a theoretical limit.

2. The micro-scale chemical network system for real-time sensing and manipulating the intermediate compounding process in dye chemistry according to claim 1, wherein in the primary intermediate compounding reaction process, prior to the reaction, the primary real-time sensing module is configured to sense the micro-scale chemical information of the artificially prepared raw material 1-1 in a raw material tank in real time, and the micro-scale chemical information and the macro-scale physical information of the liquid in the tank prior to the reaction, wherein the micro-scale chemical information of the artificially prepared raw material 1-1 comprise the purity and solid content of intermediate D in the artificially prepared raw material 1-1, the micro-scale chemical information of the liquid in the tank prior to the reaction comprise a content of intermediate D and a content of sulfuric acid in the liquid in the tank prior to the reaction, and the macro-scale physical information of the liquid in the tank prior to the reaction comprise total amount of solution in the tank prior to the reaction, and to upload data to the primary model of the chemical decision-making module; the primary intermediate D and acidic liquid accurate addition optimal control model is configured to predict the theoretical addition amounts of the raw material 1-1 and the raw material 1-2 and accurately control the addition rates by dynamically interlocking the electric control valves corresponding to the raw material 1-1 and the raw material 1-2 by the primary compounding manipulation module; during reaction, the primary real-time sensing module is configured to sense a change rate of the content of intermediate D with time and stability of acidity in the primary compounding reaction vessel in real time, during which the primary model of the chemical decision-making module is configured to circularly analyze and determine the deviation between the real-time sensed actual value of the intermediate and the model-predicted theoretical value and to perform self-adjustment on the model algorithm to correct the deviation until the primary intermediate compounded liquid reaches the theoretical limit, the primary compounding manipulation module is configured to interlockingly control the electric control valves corresponding to the raw material 1-1 and the raw material 1-2 to be closed; when the reaction stops, the primary compounding manipulation module opens a drain valve of the primary compounding reaction vessel to ensure that the content of intermediate D and the acidity in a primary compounded effluent reach the theoretical limit.

3. The micro-scale chemical network system for real-time sensing and manipulating the intermediate compounding process in dye chemistry according to claim 1, wherein in the secondary intermediate compounding reaction process, prior to the reaction, the secondary real-time sensing module is configured to sense the micro-scale chemical information of the artificially prepared raw material 2-1 auxiliary agent in a raw material tank in real time, and the micro-scale chemical information and the macro-scale physical information of the liquid in the tank prior to the reaction, wherein the micro-scale chemical information of the artificially prepared raw material 2-1 auxiliary agent comprise the purity and solid content of auxiliary agent in the artificially prepared raw material 2-1, the micro-scale chemical information of the liquid in the tank prior to the reaction comprise a content of intermediate D and a content of sulfuric acid in the liquid in the tank prior to the reaction, and the macro-scale physical information of the liquid in the tank prior to the reaction comprise total amount of solution in the tank prior to the reaction, and to upload data to the secondary model of the chemical decision-making module; a secondary auxiliary agent and acidic liquid accurate addition optimal control model is configured to predict the theoretical addition amounts of the raw material 2-1 and the raw material 2-2 and accurately control the addition rates by dynamically interlocking the electric control valves corresponding to the raw material 2-1 and the raw material 2-2 by the compounding manipulation module; during reaction, the secondary real-time sensing module is configured to sense a change rate of the content of intermediate D and the content of auxiliary agent with time and stability of acidity in the secondary compounding reaction vessel in real time, during which the secondary model of the chemical decision-making module is configured to circularly analyze and determine the deviation between the real-time sensed actual value of the intermediate and the model-predicted theoretical value, and to perform self-adjustment on the model algorithm to correct the deviation until the secondary intermediate compounded liquid reaches the theoretical limit, the secondary compounding manipulation module is configured to interlockingly control the electric control valves corresponding to the raw material 2-1 and dilute acid to be closed; when the reaction stops, the secondary compounding manipulation module opens a drain valve of the secondary compounding reaction vessel to ensure that the content of intermediate D, the content of auxiliary agent and the acidity in a secondary compounded effluent reach the theoretical limit.

4. The micro-scale chemical network system for real-time sensing and manipulating an intermediate compounding process in dye chemistry according to claim 1, wherein in the tertiary intermediate compounding reaction process, prior to the reaction, the tertiary real-time sensing module is configured to sense the micro-scale chemical information of the artificially synthesized raw material 3-1 diazonium salt in a raw material tank in real time, and the micro-scale chemical information and the macro-scale physical information of the liquid in the tank prior to the reaction, wherein the micro-scale chemical information of the diazonium salt comprise the purity and solid content of diazonium salt, the micro-scale chemical information of the liquid in the tank prior to the reaction comprise a content of intermediate D and a content of sulfuric acid in the liquid in the tank prior to the reaction, and the macro-scale physical information of the liquid in the tank prior to the reaction comprise total amount of solution in the tank prior to the reaction, and to upload data to the tertiary model of the chemical decision-making module; a tertiary diazonium salt and acidic liquid accurate addition optimal control model is configured to predict the theoretical addition amounts of the raw material 3-1 and the raw material 3-2 and accurately control the addition rates by dynamically interlocking the electric control valves corresponding to the raw material 3-1 and the raw material 3-2 by the tertiary compounding manipulation module; during reaction, the tertiary real-time sensing module is configured to sense a change rate of the content of intermediate D and the content of diazonium salt with time and stability of acidity in the tertiary compounding reaction vessel in real time, during which the tertiary model of the chemical decision-making module is configured to circularly analyze and determine the deviation between the real-time sensed actual value of the intermediate and the model-predicted theoretical value and to perform self-adjustment on the model algorithm to correct the deviation until the tertiary intermediate compounded liquid reaches the theoretical limit, the tertiary compounding manipulation module is configured to interlockingly control the electric control valves corresponding to the raw material 3-1 and the raw material 3-2 to be closed; when the reaction stops, the tertiary compounding manipulation module opens a drain valve of the tertiary compounding reaction vessel to ensure that a total amount of the intermediate D, a total amount of the diazonium salt and the acidity in the tertiary compounded effluent reach the theoretical limit.

5. The micro-scale chemical network system for real-time sensing and manipulating an intermediate compounding process in dye chemistry according to claim 2, wherein optimal theoretical limits at an end point of the primary intermediate compounding reaction process are as follows: a range of the content of intermediate D is 8.2±0.2%, and the content of sulfuric acid is 3.0±0.2%.

6. The micro-scale chemical network system for real-time sensing and manipulating an intermediate compounding process in dye chemistry according to claim 3, wherein optimal theoretical limits at an end point of the secondary intermediate compounding reaction process are as follows: a range of the content of intermediate D is 2.8±0.2%, the content of auxiliary agent is 0.35%, and the content of sulfuric acid is 4.0±0.2%.

7. The micro-scale chemical network system for real-time sensing and manipulating an intermediate compounding process in dye chemistry according to claim 4, wherein optimal theoretical limits at an end point of the tertiary intermediate compounding reaction process are as follows: the total amount of intermediate D:diazonium salt=1:1 by molar ratio=206.14:325.94 by mass ratio=0.33 t/h:0.52 t/h by flow ratio, and the content of sulfuric acid is 2.5±0.2%.

8. A micro-scale chemical network method for real-time sensing and manipulating an intermediate compounding process applied to the system according to claim 1, comprising:
S1: introducing circulating acidic liquid containing residual amounts of intermediate D species into an intermediate compounding reaction system, and enabling the circulating acidic liquid to flow sequentially in respective reaction tanks in the primary compounding process, the secondary compounding process, and the tertiary compounding process;
S2: enabling the circulating acidic liquid to enter the primary intermediate compounding reaction process, acquiring the micro-scale chemical information and the macro-scale physical information of liquid in the primary compounding process by the primary real-time sensing module, and determining an addition amount of a raw material through feedforward prediction and feedback correction of the primary intermediate D and acidic liquid accurate addition optimal model in the chemical decision-making module, achieving accurate addition through dynamical interlocking by the primary compounding manipulation module, and ending the reaction when a theoretical limit is reached,
S3: enabling a primary effluent to enter the secondary intermediate compounding reaction process, acquiring the micro-scale chemical information and the macro-scale physical information of liquid in the secondary compounding process by the secondary real-time sensing module, and determining an addition amount of a raw material through feedforward prediction and feedback correction of the secondary auxiliary agent and acidic liquid accurate addition optimal model in the chemical decision-making module, achieving accurate addition through dynamical interlocking by the secondary compounding manipulation module, and ending the reaction when a theoretical limit is reached; and
S4: enabling a secondary effluent to enter the tertiary intermediate compounding reaction process, acquiring the micro-scale chemical information and the macro-scale physical information of liquid in the tertiary compounding process by the tertiary real-time sensing module, and determining an addition amount of a raw material by feedforward prediction and feedback correction of the tertiary diazonium salt and acidic liquid accurate addition optimal model in the chemical decision-making module, achieving accurate addition through dynamical interlocking by the tertiary compounding manipulation module, and ending the reaction when a theoretical limit is reached; and enabling a tertiary effluent to enter a next reaction unit coupling system.

9. The micro-scale chemical network method according to claim 8, wherein in the primary intermediate compounding reaction process, prior to the reaction, the primary real-time sensing module is configured to sense the micro-scale chemical information of the artificially prepared raw material 1-1 in a raw material tank in real time, and the micro-scale chemical information and the macro-scale physical information of the liquid in the tank prior to the reaction, wherein the micro-scale chemical information of the artificially prepared raw material 1-1 comprise the purity and solid content of intermediate D in the artificially prepared raw material 1-1, the micro-scale chemical information of the liquid in the tank prior to the reaction comprise a content of intermediate D and a content of sulfuric acid in the liquid in the tank prior to the reaction, and the macro-scale physical information of the liquid in the tank prior to the reaction comprise total amount of solution in the tank prior to the reaction, and to upload data to the primary model of the chemical decision-making module; the primary intermediate D and acidic liquid accurate addition optimal control model is configured to predict the theoretical addition amounts of the raw material 1-1 and the raw material 1-2 and accurately control the addition rates by dynamically interlocking the electric control valves corresponding to the raw material 1-1 and the raw material 1-2 by the primary compounding manipulation module; during reaction, the primary real-time sensing module is configured to sense a change rate of the content of intermediate D with time and stability of acidity in the primary compounding reaction vessel in real time, during which the primary model of the chemical decision-making module is configured to circularly analyze and determine the deviation between the real-time sensed actual value of the intermediate and the model-predicted theoretical value and to perform self-adjustment on the model algorithm to correct the deviation until the primary intermediate compounded liquid reaches the theoretical limit, the primary compounding manipulation module is configured to interlockingly control the electric control valves corresponding to the raw material 1-1 and the raw material 1-2 to be closed; when the reaction stops, the primary compounding manipulation module opens a drain valve of the primary compounding reaction vessel to ensure that the content of intermediate D and the acidity in a primary compounded effluent reach the theoretical limit.

10. The micro-scale chemical network method according to claim 8, wherein in the secondary intermediate compounding reaction process, prior to the reaction, the secondary real-time sensing module is configured to sense the micro-scale chemical information of the artificially prepared raw material 2-1 auxiliary agent in a raw material tank in real time, and the micro-scale chemical information and the macro-scale physical information of the liquid in the tank prior to the reaction, wherein the micro-scale chemical information of the artificially prepared raw material 2-1 auxiliary agent comprise the purity and solid content of auxiliary agent in the artificially prepared raw material 2-1, the micro-scale chemical information of the liquid in the tank prior to the reaction comprise a content of intermediate D and a content of sulfuric acid in the liquid in the tank prior to the reaction, and the macro-scale physical information of the liquid in the tank prior to the reaction comprise total amount of solution in the tank prior to the reaction, and to upload data to the secondary model of the chemical decision-making module; a secondary auxiliary agent and acidic liquid accurate addition optimal control model is configured to predict the theoretical addition amounts of the raw material 2-1 and the raw material 2-2 and accurately control the addition rates by dynamically interlocking the electric control valves corresponding to the raw material 2-1 and the raw material 2-2 by the compounding manipulation module; during reaction, the secondary real-time sensing module is configured to sense a change rate of the content of intermediate D and the content of auxiliary agent with time and stability of acidity in the secondary compounding reaction vessel in real time, during which the secondary model of the chemical decision-making module is configured to circularly analyze and determine the deviation between the real-time sensed actual value of the intermediate and the model-predicted theoretical value, and to perform self-adjustment on the model algorithm to correct the deviation until the secondary intermediate compounded liquid reaches the theoretical limit, the secondary compounding manipulation module is configured to interlockingly control the electric control valves corresponding to the raw material 2-1 and dilute acid to be closed; when the reaction stops, the secondary compounding manipulation module opens a drain valve of the secondary compounding reaction vessel to ensure that the content of intermediate D, the content of auxiliary agent and the acidity in a secondary compounded effluent reach the theoretical limit.

11. The micro-scale chemical network method according to claim 8, wherein in the tertiary intermediate compounding reaction process, prior to the reaction, the tertiary real-time sensing module is configured to sense the micro-scale chemical information of the artificially synthesized raw material 3-1 diazonium salt in a raw material tank in real time, and the micro-scale chemical information and the macro-scale physical information of the liquid in the tank prior to the reaction, wherein the micro-scale chemical information of the diazonium salt comprise the purity and solid content of diazonium salt, the micro-scale chemical information of the liquid in the tank prior to the reaction comprise a content of intermediate D and a content of sulfuric acid in the liquid in the tank prior to the reaction, and the macro-scale physical information of the liquid in the tank prior to the reaction comprise total amount of solution in the tank prior to the reaction, and to upload data to the tertiary model of the chemical decision-making module; a tertiary diazonium salt and acidic liquid accurate addition optimal control model is configured to predict the theoretical addition amounts of the raw material 3-1 and the raw material 3-2 and accurately control the addition rates by dynamically interlocking the electric control valves corresponding to the raw material 3-1 and the raw material 3-2 by the tertiary compounding manipulation module; during reaction, the tertiary real-time sensing module is configured to sense a change rate of the content of intermediate D and the content of diazonium salt with time and stability of acidity in the tertiary compounding reaction vessel in real time, during which the tertiary model of the chemical decision-making module is configured to circularly analyze and determine the deviation between the real-time sensed actual value of the intermediate and the model-predicted theoretical value and to perform self-adjustment on the model algorithm to correct the deviation until the tertiary intermediate compounded liquid reaches the theoretical limit, the tertiary compounding manipulation module is configured to interlockingly control the electric control valves corresponding to the raw material 3-1 and the raw material 3-2 to be closed; when the reaction stops, the tertiary compounding manipulation module opens a drain valve of the tertiary compounding reaction vessel to ensure that a total amount of the intermediate D, a total amount of the diazonium salt and the acidity in the tertiary compounded effluent reach the theoretical limit.

12. The micro-scale chemical network method according to claim 9, wherein optimal theoretical limits at an end point of the primary intermediate compounding reaction process are as follows: a range of the content of intermediate D is 8.2±0.2%, and the content of sulfuric acid is 3.0±0.2%.

13. The micro-scale chemical network method according to claim 10, wherein optimal theoretical limits at an end point of the secondary intermediate compounding reaction process are as follows: a range of the content of intermediate D is 2.8±0.2%, the content of auxiliary agent is 0.35%, and the content of sulfuric acid is 4.0±0.2%.

14. The micro-scale chemical network method according to claim 11, wherein optimal theoretical limits at an end point of the tertiary intermediate compounding reaction process are as follows: the total amount of intermediate D:diazonium salt=1:1 by molar ratio=206.14:325.94 by mass ratio=0.33 t/h:0.52 t/h by flow ratio, and the content of sulfuric acid is 2.5±0.2%.
